(19) United States
(12) Patent Application Publication
(10) Pub. No.: US 2009/0263185 A1
(43) Pub. Date: Oct. 22, 2009

(54) Rebar splice sleeve and method of splicing

(76) Inventor: Alfred A. Yee, Honolulu, HI (US)

Correspondence Address: JACOBSON HOLMAN PLLC, 400 SEVENTH STREET N.W., SUITE 600, WASHINGTON, DC, 20004, US

(21) Appl. No.: 12/081,539

(22) Filed: Apr. 17, 2008

(51) Int. Cl. F16D 1/027; E04B 1/00

(52) U.S. Cl. 403/314; 52/741.1

(57) ABSTRACT

A splice sleeve for receiving and connecting adjoining ends of a pair of reinforcing bars with one end having an enlarged end and the other end without an enlargement. The splice sleeve has an internal surface which is generally cylindrical with ridges over a major portion of its length starting at one open end and steeply tapered inwardly toward a smaller opening on the other end. The sleeve's inwardly tapered end is complementarily configured to captively receive and lock in place the enlarged head of the first rebar end. The second rebar end is inserted into the sleeve's cylindrical portion up to the enlarged end of the first rebar, and the sleeve is filled with high strength grout through side ports to hold the bar ends in a coupled arrangement.

### BACKGROUND OF THE INVENTION

1. Field of the Invention

The present invention relates generally to a splice sleeve for reinforcing bars utilized in concrete wall, beam, floor slab structures or columns and, more particularly, to a splice sleeve having a longitudinally elongated shell of lesser length which allows for more reliable, easier and faster installation.

2. Description of the Prior Art

Various devices for splicing sections of reinforcing bar (i.e., “rebar”) are known. More specifically, various grouted splice sleeves for joining a pair of opposed rebar ends are known. For example, my U.S. Pat. No. 4,627,212, the disclosure of which is expressly incorporated by reference herein as if fully set forth, discloses a splice sleeve in which both ends of the interior surface of the sleeve are provided with annular ridges. The annular space between the interior of the sleeve and the exterior of the reinforcing bars is filled with grouting with the ribs on the bars and the ridges on the sleeve interlocking the bars within the sleeve for fixedly connecting and generally aligning the ends of the reinforcing bars. In one embodiment, the splice sleeve has a cylindrical surface over at least one-half of its length with one end portion of the sleeve having either a gradually tapering internal and external surface or a cylindrical surface terminating in a relatively short frusto-conical portion with inwardly tapering internal and external surfaces. The rebar that is used in the splice sleeve has a cylindrical, i.e., non-headed end.

To enhance the strength of the rebar splice, U.S. Pat. No. 6,192,647 to Dahl discloses a grouted pipe coupler in which the rebar ends include an enlarged head 6. The interior of the Dahl device has a uniform diameter.

To provide an even stronger rebar coupling, however, it is desirable to provide a sleeve having an elongated interior section for one of the rebars. By seating a rebar having an enlarged end in the mouth of one end of a tapered sleeve end, it is possible to provide the elongated interior for the opposite bar end.

### SUMMARY OF THE INVENTION

The present invention is directed to a splice sleeve or coupler and method for coupling a pair of reinforcing bar (“rebar”) ends, or the like. The splice sleeve or coupler includes a tubular sleeve with two side ports, a steeply tapered portion opening at one end which makes up a minor extent of the tubular sleeve and a cylindrical portion with spaced internal ribs opening at the opposite end which makes up a major extent of the tubular sleeve. The opening at the cylindrical end of the sleeve is thus larger than the smaller opening at the tapered end, which latter opening is sized to be only slightly larger than the diameter of the rebar to allow tolerance in the installation procedure.

A first rebar has its end deformed into an enlarged diameter end or head that is captively received into the sleeve's minor extent, tapered end when the first rebar extends out through the sleeve's smaller opening. A second rebar end without an enlarged head is inserted into the sleeve's cylindrical major portion and positioned adjacent the enlarged head of the first rebar. The sleeve is then filled with a high strength grout or other cementious type material to hold the bar ends coupled together. This arrangement allows the rebar end with the enlarged head to be captured or locked in the complementary tapered end with only minor extension into the interior of the sleeve. And, the rebar end without the enlarged head can then occupy a longer or major extent of the sleeve length for better securement with the grout and sleeve interior. In a preferred embodiment, the opening in the side port adjacent the steeply tapered opening is smaller than the opening in the side port adjacent the opposed cylindrical opening to assist in grout filling.

The method for coupling a pair or rebar ends in accordance with the present invention includes the following steps:

(1) Provide a spliced sleeve having a configuration as described in the preceding paragraph;

(2) Form an enlarged head or end on a first rebar and insert the other end of the headed rebar all the way into the sleeve through the cylindrical opening so that the enlarged head sits snugly into the steeply tapered opening at one end of the sleeve;

(3) Insert an end of the second rebar which end has no enlarged head into the cylindrical major extent of the tubular sleeve until it is positioned adjacent the enlarged end of the first rebar;

(4) Pump high strength grout or other cementious material into the side port adjacent the cylindrical opening while closing off the cylindrical opening until the high strength grout fills the interior of the sleeve surrounding the rebar ends as indicated by grout exiting the smaller side port adjacent the tapered opening; and

(5) Allow the high strength grout or other cementious material to cure with the adjacent rebar ends fixedly secured in the splice sleeve.

Accordingly, it is an object of the present invention to provide a splice sleeve and method for connecting the ends of generally aligned reinforcing bars with the sleeve having a generally cylindrical external surface with a shorter length for use in concrete beams, floor slabs, walls and in columns.

Another object of the present invention is to provide a splice sleeve having a generally cylindrical interior surface with one end that terminates in a minor, or relatively short frusto-conical, or tapered, portion with an inwardly tapering surface, and the other end with a major, or relatively long, cylindrical portion.

Still another object of the present invention is to provide a splice sleeve configured to seat a rebar having an enlarged head or end in the complementary frusto-conical minor portion of the sleeve so as to provide an elongated cylindrical major portion for the other bar end.

A still further another object of the present invention is to provide a splice sleeve for reinforcing bars in accordance with the preceding objects in which the splice sleeve is provided with ports adjacent the ends thereof with one port being smaller than the other to enable the interior of the shell to be filled completely with high strength grout or other cementious material so that the entire annular space between the exterior of the reinforcing bar ends and the interior of the shell will be filled with grouting.

A further object of the present invention is to provide a splice sleeve in accordance with the preceding objects in which the internal surface of the cylindrical major portion has annular ridges spaced along its length to cooperate with the ribs on the reinforcing bars and grouting filling the space between the reinforcing bars and the internal surface of the shell to rigidly secure the reinforcing bars, grouting and shell into a fixedly interconnected unit.

Yet a further object of the present invention is to provide a splice sleeve in accordance with the preceding objects which is effective for connecting the ends of reinforcing bars.

Yet still another object of this invention to be specifically enumerated herein is to provide a splice sleeve in accordance with the preceding objects that will conform to conventional forms of manufacture, be of relatively simple construction and easy to use so as to provide a device that will be more reliable, economically feasible, long lasting, durable in service, relatively trouble free in operation, and a general improvement in the art.

These together with other objects and advantages which will become subsequently apparent reside in the details of construction and operation as more fully hereinafter described and claimed, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1 is a perspective side view of a splice sleeve receiving aligned ends of opposed rebar for interconnecting in accordance with one embodiment of the present invention.

FIG. 2 is a top plan view of the splice sleeve shown in FIG. 1.

FIG. 3 is a vertical sectional view of the splice sleeve of FIG. 1 along line 3-3 shown in FIG. 2.

FIG. 4 is a sectional view of the splice sleeve of FIG. 1 along line 4-4 shown in FIG. 3.

FIG. 5 is a sectional view of the splice sleeve of FIG. 1 along line 5-5 in FIG. 3.

FIGS. 6A-6E are a series of sectional views illustrating a sequence of steps for assembling a pair of rebar ends into the splice sleeve shown in FIG. 1 in accordance with the present invention.

FIG. 7 is a side view illustrating a series of rebar sections interconnected by the splice sleeve of the present invention.

### DETAILED DESCRIPTION OF THE PREFERRED EMBODIMENTS

Although preferred embodiments of the invention are explained in detail, it is to be understood that other embodiments are possible. Accordingly, it is not intended that the invention is to be limited in its scope to the details of constructions, and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents that operate in a similar manner to accomplish a similar purpose. Where possible, components of the drawings that are alike are identified by the same reference numbers.

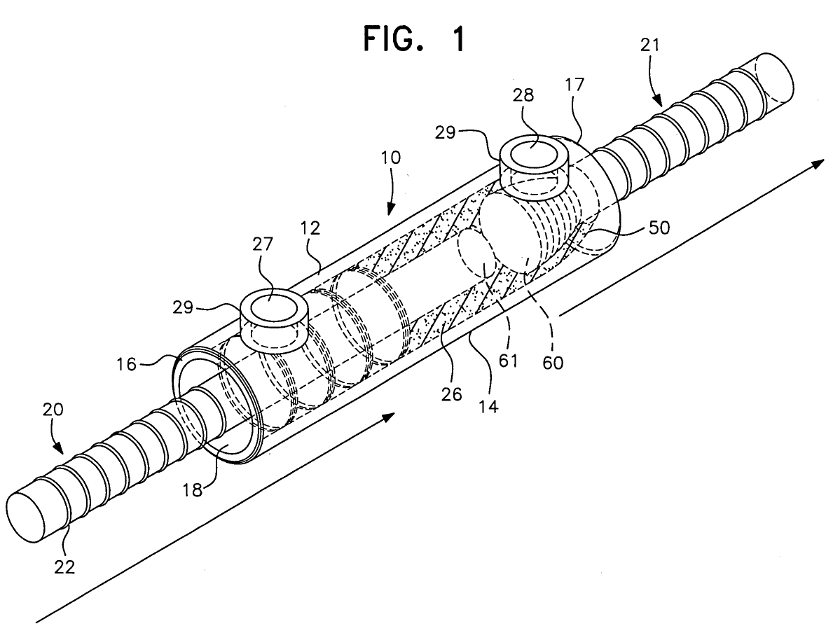

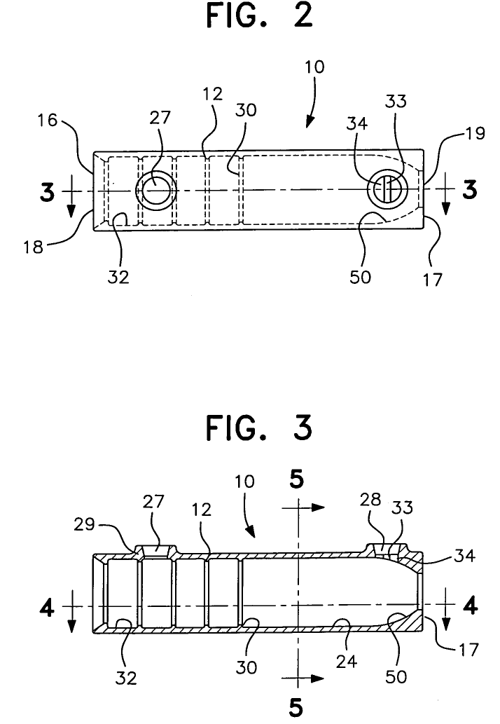

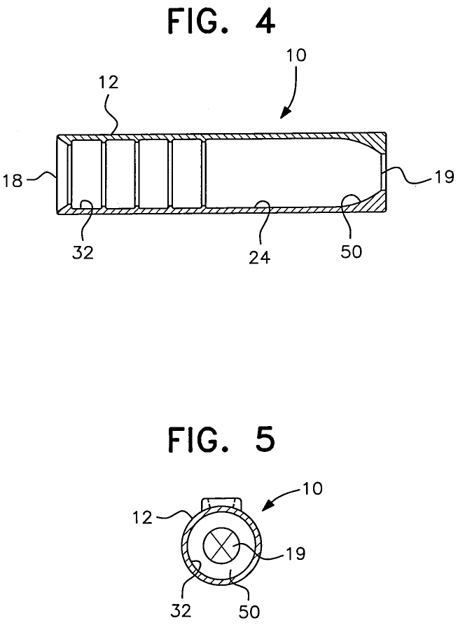

Referring now specifically to the drawings, the splice sleeve of the present invention illustrated in FIGS. 1-4 is generally designated by reference numeral 10 and includes a one-piece elongated shell 12 constructed of metal, such as cast steel or the like. The shell 12 includes a cylindrical external surface 14 having the same diameter substantially throughout its length and end surfaces 16 and 17 generally perpendicular thereto. The end surfaces 16 and 17 are each provided with an opening or aperture 18 and 19, respectively, centrally located therein for receiving the end portions of reinforcing bars 20 and 21 which include external annular ribs or ridges 22. The reinforcing bars 20 and 21 are of conventional construction, but each includes an enlarged head or end 60, i.e., a rebar having a enlarged diameter, or headed end. According to one embodiment, the headed end 60 is tapered.

The splice sleeve 10 includes an internal surface 24 which has a generally cylindrical portion 32 over a major extent of the sleeve, starting with the cylindrical opening 18 at end 16. The generally cylindrical portion 32 is preferably between about 75% and about 90% of the sleeve length, depending upon the diameter of the reinforcing bars to be spliced. At the other end 17, the internal surface 24 includes a steeply wedged portion 50 which inwardly tapers over a minor extent of the sleeve length, and forms into the smaller circular opening 19. The steeply wedged portion 50 extends preferably only about 10% to about 25% of the sleeve length, depending upon the diameter of the reinforcing bars to be spliced. Preferably, the opening 19 is sized to be slightly larger than the diameter of the rebar to assist in allowing the unheaded portion of the headed reinforcing bar to pull through and lock its headed end in the sleeve.

As illustrated, the internal surface 32 of the cylindrical major portion of the shell 12 includes a plurality of substantially equally spaced annular ridges 30 which preferably are all of equal height or radial dimension from the internal surface 32. Thus, by steeply tapering inwardly portion 50 of the internal surface 24, there is provided a tapered or frustoconical end portion over a minor extent of the sleeve with a cylindrical portion over a major extent of the sleeve.

The internal tapered surface 50 of the shell 12 is complementarily configured to wedgingly and captively receive the headed end 60 of rebar 21. There are many known ways to cold forge a rebar end to form an enlarged head, such as headed end 60 of rebar 21. For example, one such method is disclosed in U.S. Pat. No. 5,709,121, in which a steel reinforcing bar end is hydraulically forged to form the head.

The sleeve 10 includes a pair of grouting ports 27 and 28 which are defined by short projecting bosses 29 on the exterior of the shell 12, with each port adjacent respective ends 16 and 17 of the sleeve. The opening in port 27, adjacent end 16 is larger than the opening 33 of port 28 adjacent end 17, which latter port 28 has a portion closed off by extensions 34.

With rebar 21 having enlarged head 60 formed thereon, the rebar ends are ready to be spliced in the sleeve 10. Rebar 21 is inserted first with the end opposite the headed end 60 inserted through opening 18 until the headed end 16 is wedgedly seated and fitted in the complementary tapered surface 50 with the rebar shaft extending outwardly from end surface 17, as shown in FIG. 1. The headed end 60 of rebar 21 thus occupies only a minor portion, i.e., about 10% to about 25%, of the sleeve length. One end of rebar 20, which has no headed end, is then inserted into the sleeve 10 through opening 18 until the inner ends of rebars 20 and 21 are adjacent in close proximity to each other. Thus the end of rebar 21 occupies a major portion of the length of sleeve 10, approximately about 75% to 90%. The annular space between the internal surface of the sleeve 10 and the portions of the reinforcing bars 20 and 21 in the sleeve between ends 16 and 17 is then completely filled with a flowable and subsequently hardenable material 26, such as for example high strength grout.

In a preferred embodiment, the grout is inserted under pressure into the annular space through the opening of port 27 while the opening 18 is closed off around the shaft of rebar 20. The grout is pumped into port 27 until grout, through restricted discharge, exits the smaller opening 33 of port 28, which indicates that all open space inside the sleeve and around the rebar ends, including the headed end 60 of rebar 21, has been completely filled. The wedging shape of enlarged head 60 in cooperation with the steeply inclined surface 50, and the smaller size of opening 19, serve to close off the opening 19 during insertion of the grout into the interior of the sleeve 10. Once filled, the hardenable material or grout 26 inside shell 12 is permitted to cure.

The tapering of the complementary internal surface 50 which produces a wedging or compression action on the headed end 60 of rebar 21 together with the annular ridges 30 over the cylindrical major portion inside the sleeve 10 and the ribs 22 on the extra length of reinforcing bar extending into the sleeve provide a very secure and rigid bond and interaction between the grout 26, the reinforcing bars 20 and 21, and the cylindrical shell 12 of the spliced sleeve 10.

By using a cylindrical internal surface over a major portion of sleeve length and a tapering internal surface 50 over a minor portion, a splice sleeve of less overall length can be used to effectively connect the reinforcing bars. The splice sleeve can thus be constructed with less total length and steel quantity thereby enabling economic benefits while providing increased strength and reliability as compared with prior art splice sleeves, such as disclosed in my prior U.S. Pat. No. 4,627,212.

When the high strength grout is inserted after the reinforcing bars have been positioned in the sleeve, the grout expands and hardens into intimate contact with the ridges or grooves 22 formed on the exterior of the reinforcing bars and the ridges or grooves 30 formed on the inner cylindrical surface 32 of the sleeve. This action creates a positive locking engagement between the splice sleeve 10, the grout 26 and reinforcing bars 20 and 21. Forces exerted on the reinforcing bars to move them longitudinally outwardly after the grouting has hardened is more effectively resisted due to the wedge shaped action of the inwardly tapering internal surface 50. This provides a wedging or locking action with respect to the grout and this construction provides a positive wedge-like retainment of the grout encased ends of the reinforcing bars in the splice sleeve.

Furthermore, by virtue of engaging the headed end 60 with the internal tapered end 50, an even more secure engagement is made. By virtue of the using the internal tapered surface 50 in conjunction with the headed end 60, the longitudinal space that is required for one of the rebars in a conventional sleeve is reduced. This means that the savings in longitudinal space associated with housing rebar 21 can be devoted to housing the other coupled rebar 20. This configuration therefore provides additional longitudinal space for securing rebar 20. Accordingly, the strength of the coupling can be enhanced.

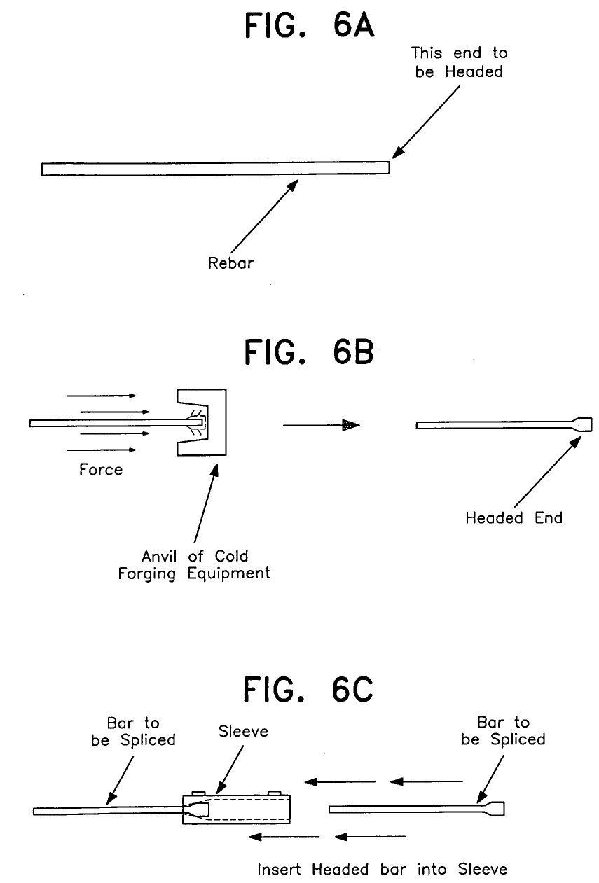

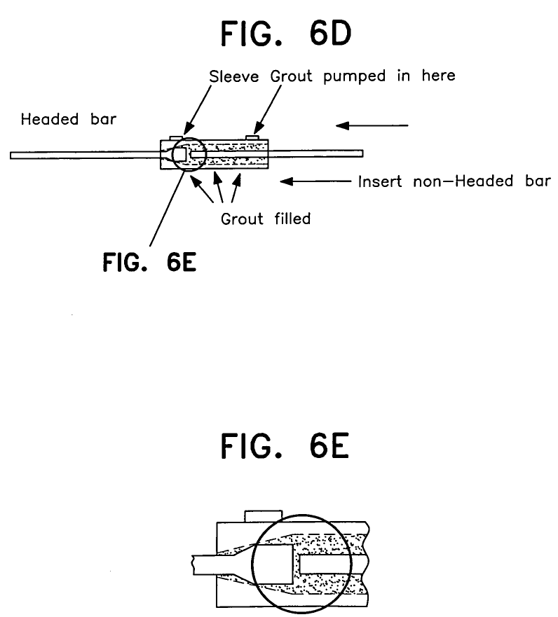

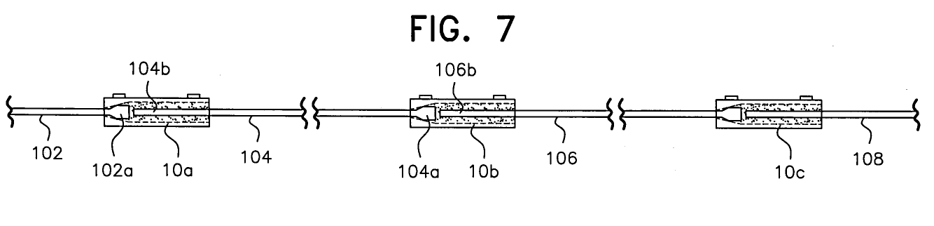

Referring now to FIGS. 6A-E, a method of assembling the splice sleeve 10 is explained. As illustrated by FIGS. 6A and 6B, the headed end 60 for rebar 21 is first formed. The opposite end of rebar 21 is then inserted in shell 12 through opening 18 so that headed end 60 is captively secured by the internal tapered surface 50 and the opposite end projects out of opening 19. Next rebar 20 is inserted in shell 12 through opening 18 so that its unheaded end 61 is in close proximity to the headed end 60 of rebar 21. High strength grout 26 is then pumped into shell 12 through port 27 so as to surround the inserted rebars 20, 21. A detailed view of the structure and association of the splice sleeve 10 with the reinforcing bars 20 and 21 is shown in FIG. 6E.

As explained above, an important feature of the splice sleeve of the present invention is to splice together opposed ends of reinforcing bars, or rebar sections, one of which ends includes an enlarged diameter head or end and the other of which has a conventional end. As such, it will be appreciated by those skilled in the art that when assembling a series of rebar ends using the splice sleeve of the present invention, each reinforcing bar or rebar section is the same with one end including the enlarged head and the other end remaining untreated or conventional.

The interconnection of a series of rebar sections by the splice sleeve of the present invention is illustrated in FIG. 7, where a series of four rebar sections 102, 104, 106 and 108 are interconnected by splice sleeves 10a, 10b and 10c. When assembling a series of rebar sections in accordance with the present invention, it will be understood that, starting with rebar section 102, the enlarged head 102a is positioned within splice sleeve 10a before the rebar section 102 is positioned into the concrete or other material to be reinforced. When the rebar section 102 is then ready to be spliced with the next rebar section 104 in splice sleeve 10a, the non-enlarged end 104b of rebar 104 must be fitted onto a second splice sleeve 10b before the untreated end 104b of rebar 104 is grouted in place adjacent to the enlarged head 102a of the first rebar 102 already positioned in place in the first splice sleeve 10a.

The assembly of the next rebar section 106 follows the same procedure described above. More specifically, the non-enlarged end 106b of rebar 106 must be fitted into the third splice sleeve 10c before the untreated end 106b is grouted in place adjacent enlarged head 104a in the second splice sleeve 10b. Such is the same for the next assembly of rebar section 108 in splice sleeve 10c, and so on, until all of the rebar sections have been spliced together.

It is not intended that the present invention be limited to the specific device described herein. The foregoing is considered as illustrative only of the principles of the invention. For example, although the headed end of the rebar has been described as being formed by cold forging, other methods of providing the headed end may be possible as long as they provide a headed end that fulfills the service requirements of the present invention.

Further, numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A splice sleeve for connecting adjacent end portions of reinforcing bars in reinforced concrete construction comprising an elongated shell of one-piece construction including generally cylindrical internal and external surfaces and opposed ends each having an opening for positioning the end portions of the reinforcing bars to be connected, said internal surface being cylindrical throughout a major portion of its length from a first open end and being steeply tapered inwardly over a minor portion of its length leading to a smaller second opening at an opposite end, said inwardly tapered minor portion configured to captively secure an enlarged diameter end of a first reinforcing bar, said internal surface configured to provide a wedging action and radial inward compression for a flowable and hardenable material inserted into the annular space between the reinforcing bars and the internal surface of the shell thereby securing the shell, inserted material, and reinforcing bars fixedly throughout the length of the splice sleeve.

2. The splice sleeve according to claim 1, wherein the inserted flowable and hardenable material is a high strength grout.

3. The splice sleeve according to claim 1, wherein the steep inwardly tapered portion has a generally frusto-conical shape.

4. The splice sleeve according to claim 1, wherein the enlarged diameter end of the first reinforcing bar is tapered.

5. The splice sleeve according to claim 4, wherein the enlarged diameter end of the first reinforcing bar has a frusto-conical shape.

6. The splice sleeve according to claim 1, wherein the sleeve connects the first reinforcing bar and a second reinforcing bar, each of the first and second reinforcing bars having the enlarged diameter end on a first end and a second end without an enlarged diameter end.

7. The splice sleeve according to claim 1, wherein the sleeve connects the first reinforcing bar with a second reinforcing bar in a configuration in which the enlarged diameter end of the first bar is arranged adjacent an end of the second bar without an enlarged diameter end.

8. The splice sleeve according to claim 7, wherein the connected first and second reinforcing bars are in a configuration in which a major portion of a length of the shell is occupied by the second reinforcing bar.

9. The splice sleeve according to claim 1, wherein the elongated shell includes side port openings adjacent each of said ends.

10. The splice sleeve according to claim 9, wherein the port opening adjacent said end having a steep inwardly tapered portion is smaller than the port adjacent the cylindrically open end.

11. The splice sleeve according to claim 1, wherein said cylindrical internal surface throughout a major portion of the length of said sleeve extends from one end about 75% to about 90% the length of the sleeve.

12. An interconnected coupling of a pair of reinforcing bars comprising a splice sleeve having an internal surface which is generally cylindrical throughout a major portion of a length of the sleeve from one sleeve open end and has a steep inwardly tapered portion leading to a smaller opening over a minor portion of the sleeve length at the sleeve other end, a first reinforcing bar with an enlarged diameter end extending out of said smaller opening while said enlarged diameter end is lockingly secured in said steep inwardly tapered portion, a second reinforcing bar having an end without an enlarged head extending into said cylindrical major portion of the sleeve length, and high strength grout filling the space between the internal surface of the sleeve and said rebar ends positioned within said sleeve.

13. The interconnected coupling according to claim 12, wherein said generally cylindrical major portion is about 75% to about 90% of the length of the splice sleeve, and said steep inwardly tapered portion is about 10% to about 25% of the length of the splice sleeve.

14. The interconnected coupling according to claim 12, wherein the splice sleeve includes a pair of side port openings adjacent each of said ends for introduction of said high strength grout into said splice sleeve.

15. The interconnected coupling according to claim 14, wherein the port opening adjacent the cylindrically open end is larger than the port opening adjacent the steep inwardly tapered end so that grout inserted under pressure into the larger port opening will undergo restricted discharge through the other port opening.

16. The interconnected coupling according to claim 12, wherein said end of the second reinforcing bar is positioned in alignment with and next to said enlarged diameter end of the first reinforcing bar within said splice sleeve.

17. A method of splicing together two sections of rebar, comprising:
inserting a first reinforcing bar having an enlarged diameter end into a splice sleeve that has a complementary steep inwardly tapered portion at one end and position said enlarged diameter end in said complementary inwardly tapered portion;
inserting into an opposite end of the splice sleeve an end of a second reinforcing bar without an enlarged diameter end such that said end of the second bar is adjacent to the enlarged diameter end of the first bar; and
inserting into the splice sleeve a flowable and hardenable material that surrounds and secures the inserted bar ends.

18. The method of splicing together two sections of rebar according to claim 17, wherein said flowable and hardenable material is high strength grout.

19. The method of splicing together two sections of rebar according to claim 17, wherein the inserting of said rebar ends generally aligns the first and second reinforcing bars with respect to each other within a length of said splice sleeve, and said first reinforcing bar section extends from about 10% to about 25% of said sleeve length and said second reinforcing bar section extends from about 75% to about 90% of said sleeve length.

20. The method of splicing together two sections of rebar according to claim 17, wherein said splice sleeve has a pair of side port openings with one opening larger than the other, and the inserting of a flowable and hardenable material into the splice sleeve through the larger port opening creates a restricted discharge through the smaller port opening for filling open space inside said splice sleeve.
